(19) United States
(12) Patent Application Publication
(10) Pub. No.: US 2005/0252988 A1
(43) Pub. Date: Nov. 17, 2005

(54) Sprinkler having randomly swinging device

(76) Inventor: Cheng Hong Chang, Taichung (TW)

Correspondence Address: Cheng Hong Chang, P.O. Box 63-298, Taichung, 406, TW

(21) Appl. No.: 10/830,891

(22) Filed: Apr. 22, 2004

(51) Int. Cl. B05B 15/06; A01G 25/06; B05B 3/00; B05B 3/16

(52) U.S. Cl. 239/225.1; 239/200; 239/263

(57) ABSTRACT

A water sprinkler includes a base, a nozzle attached to the base and having an inlet for coupling to water reservoir and having an outlet. A tubular member is attached to the base, a flexible hose is extended through and supported by the tubular member, and includes one end attached to the outlet of the nozzle. A casing is attached to the other end of the flexible hose, and arranged to allow water from the nozzle to flow through the flexible hose and to flow out of the casing, and to force the casing to randomly swing relative to the base, and to randomly spraying the water. A cap may be attached to the casing for such as decorative purposes.

### BACKGROUND OF THE INVENTION

1. Field of the Invention

The present invention relates to a water sprinkler, and more particularly to a water sprinkler having a structure or a device that may be randomly swinging relative to the water sprinkler, in order to randomly sprinkle or spray the water.

2. Description of the Prior Art

Various kinds of typical water sprinklers have been developed for water spraying purposes, and comprise an outlet port or nozzle rotatably supported in a housing, and rotatable by a gear-and-worm driving device, a motor driving device, electromagnetic driving device, or even rotatable by the water flowing through the outlet port or nozzle of the typical water sprinklers.

For example, U.S. Pat. No. 5,772,117 to Su discloses one of the typical water sprinklers, and comprise a transmission rod and a spray head rotatably attached to a housing, and rotatable by a paddle wheel and a gear-and-worm driving device, for allowing the water to spray or flow out of the spray head, and to evenly spray the water around the typical water sprinklers when the spray head is rotated relative to the housing.

However, the conventional spray heads of the typical water sprinklers are normally rotated regularly around the typical water sprinklers, such that the water spraying or flowing out of the spray head may not randomly swinging or spraying around the water sprinklers.

The present invention has arisen to mitigate and/or obviate the afore-described disadvantages of the conventional water sprinklers.

### SUMMARY OF THE INVENTION

The primary objective of the present invention is to provide a water sprinkler including a randomly swinging structure or device for randomly sprinkling or spraying the water.

In accordance with one aspect of the invention, there is provided a water sprinkler comprising a base, a nozzle attached to the base, and including an inlet for coupling to water reservoir, and including an outlet, a tubular member attached to the base, a flexible hose extended through and supported by the tubular member, and including a first end attached to the outlet of the nozzle, and including a second end, and a casing attached to the second end of the flexible hose, and arranged to allow water from the nozzle to flow through the flexible hose and to flow out of the casing, and to force the casing to randomly swing relative to the base, and to randomly spraying the water.

The base includes a chamber formed therein, and an orifice formed in outer peripheral portion and communicating with the chamber thereof, to receive the nozzle. The base includes an opening formed therein and communicating with the chamber thereof, for allowing the nozzle to be engaged into the chamber thereof.

The base includes a cap attached thereto, to enclose the opening thereof, and to retain the nozzle within the chamber of the base. The base includes at least one projection extended downwardly therefrom, for engaging into ground.

A flexible pipe may further be provided and engaged onto the flexible hose, to resiliently support the flexible hose in position. A barrel may further be provided and attached onto the tubular member, the flexible hose being extended through the barrel. The barrel includes a bore formed therein, to receive a first end of the flexible pipe. The casing includes a bore formed therein, to receive a second end of the flexible pipe.

A cap may further be provided and attached to the casing. The casing includes a peripheral flange extended therefrom, and having at least one aperture formed therein, the cap includes at least one catch extended therefrom, and engageable through the aperture of the casing, to attach the to the casing.

A panel may further be provided and attached to the casing and secured between the casing and the cap. The cap includes a port extended therefrom, and a bore formed through the port, the port is attached to the second end of the flexible hose, and, to receive water from the flexible hose. The cap includes a protrusion partially extended into the bore of the cap, to partially shield a water flowing passage through the bore of the port.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a water sprinkler in accordance with the present invention;

FIG. 2 is a perspective view of a guide cap for the water sprinkler;

FIG. 3 is a perspective view of the water sprinkler;

FIG. 4 is a cross sectional view of the water sprinkler, taken along lines 4-4 of FIG. 3;

FIG. 5 is an enlarged partial cross sectional view of the water sprinkler;

FIG. 6 is an end plan view of the guide cap of the water sprinkler;

FIG. 7 is a cross sectional view similar to FIG. 4, illustrating the operation of the water sprinkler; and

FIG. 8 is a perspective view illustrating the operation of the water sprinkler.

### DETAILED DESCRIPTION OF THE PREFERRED EMBODIMENT

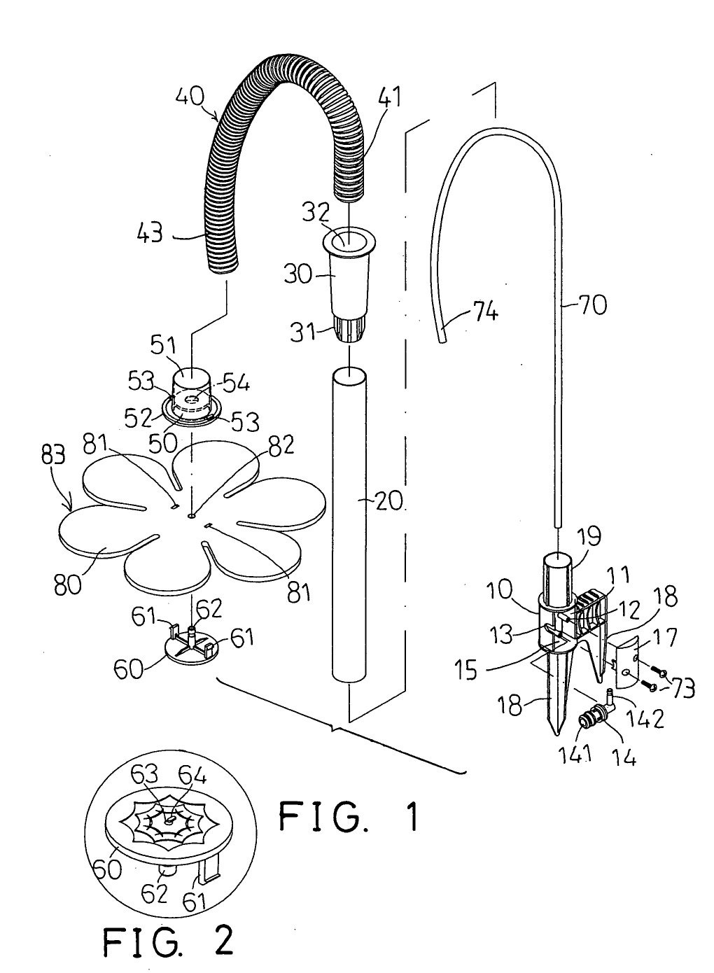

Referring to the drawings, and initially to FIGS. 1-4, a water sprinkler in accordance with the present invention comprises a base 10 including a chamber 11 formed therein, and one or more studs 12 extended within the chamber 11 thereof, and an orifice 13 formed in the outer peripheral portion and communicating with the chamber 11 thereof.

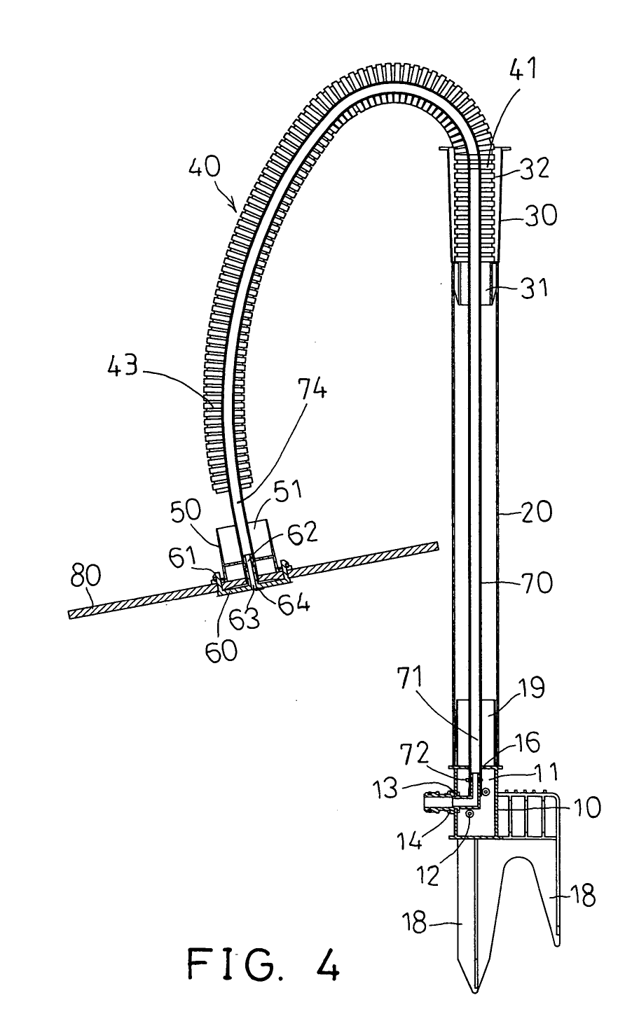

A nozzle 14 is received and secured in the orifice 13 of the base 10, and includes an inlet 141 extended out of the base 10 for coupling to water reservoir, and an outlet 142 extended or provided within the chamber 11 of the base 10. A flexible hose 70 includes one end 71 engageable through a hole 16 of the base 10 (FIGS. 4, 7), and engaged onto and secured to the outlet 12 of the nozzle 14 with such as a clamping ring 72 (FIG. 4).

The base 10 further includes an opening 15 formed therein (FIG. 1), and communicating with the chamber 11 thereof, for allowing the nozzle 14 to be engaged into the chamber 11 of the base 10. A cover 17 is attachable to the base 10, to enclose the opening 15 of the base 10. and is fixable to the base 10 with one or more fasteners 73 (FIG. 1) which may be threaded through the cover 17 and may be threaded with the studs 12 of the base 10.

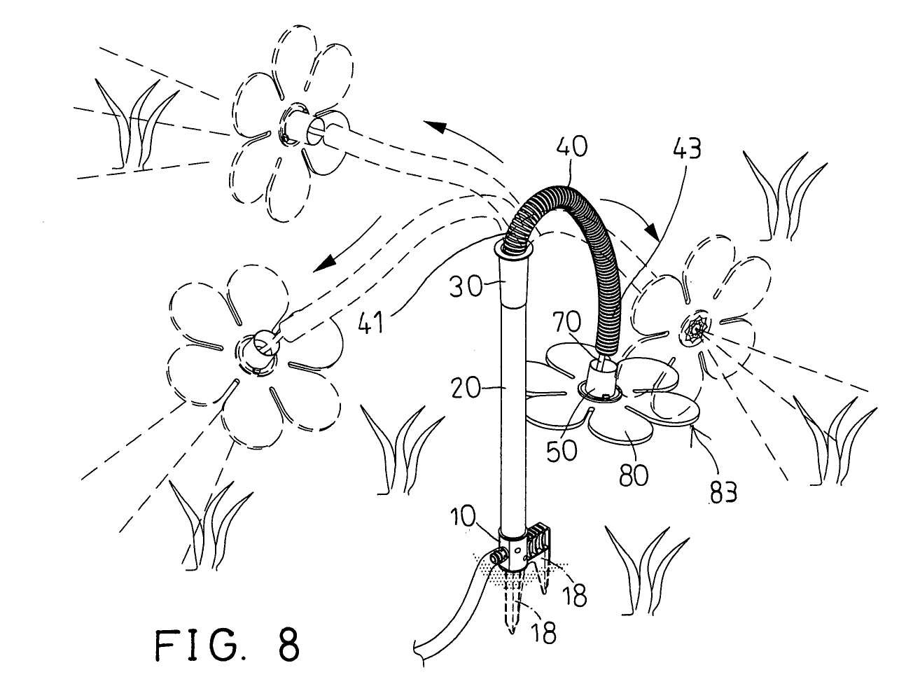

The base 10 further includes one or more projections 18 extended downwardly therefrom, for engaging into soil, and for securing or positioning the base 10 of the water sprinkler on the ground (FIG. 8). The base 10 further includes a mouth 19 formed or provided on the upper portion thereof.

A tubular member 20 may include a lower portion engaged onto or secured to the mouth 19 of the base 10, and may include a suitable hardness or stiffness, to allow the tubular member 20 to be erectly extended above the base 10 or to be extended upwardly from the base 10. The flexible hose 70 is received in the tubular member 20, and may thus also be erectly supported by the tubular member 20.

A barrel 30 is disposed or attached onto the tubular member 20, and includes a spring latch 31 formed or provided in the bottom portion for engaging into the tubular member 20, and for latching or securing the barrel 30 on top of the tubular member 20. The barrel 30 includes a bore 32 formed therein, for receiving or attaching one end 41 of a flexible pipe 40.

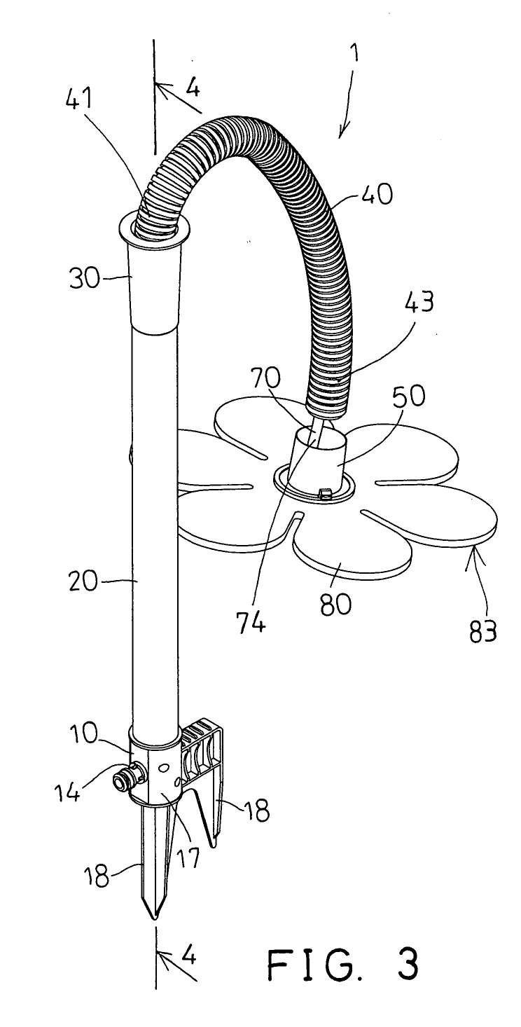

The flexible hose 70 is also extended or engaged through the flexible pipe 40 which may resiliently support the flexible hose 70 in a downwardly extended status or position, as shown in FIGS. 3, 4, and 8. The other end 74 of the flexible hose 70 is extendible out of the flexible pipe 40.

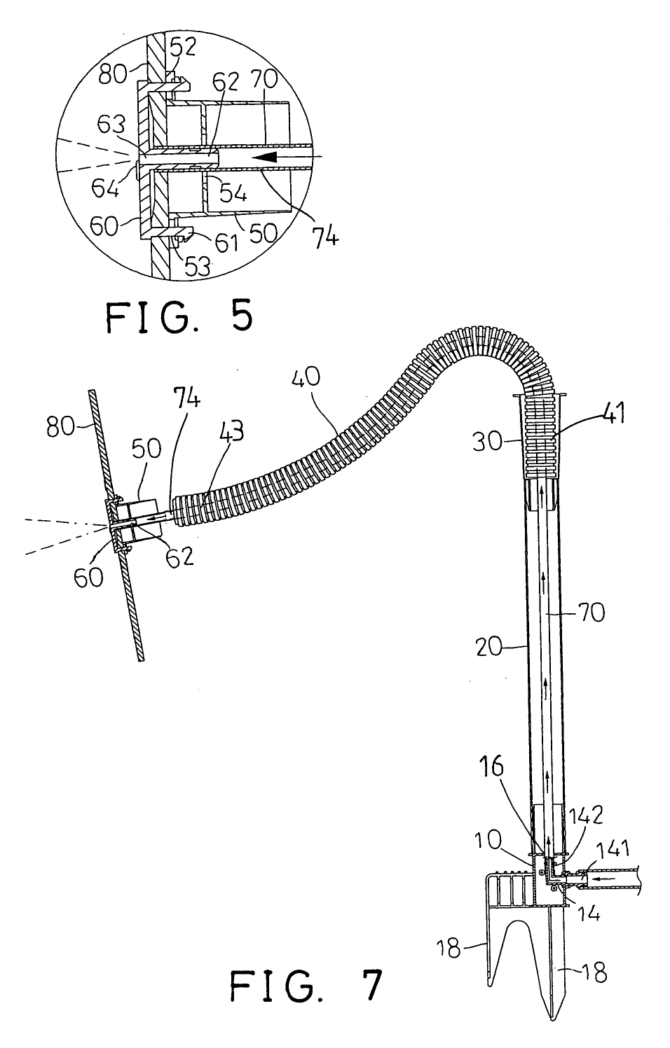

A casing 50 includes a bore 51 formed therein for, but not necessarily receiving the other end 43 of the flexible pipe 40, and includes a peripheral flange 52 laterally or radially extended outwardly therefrom, and having one or more apertures 53 formed therein. The casing 50 includes a passage 54 formed therein for receiving the other end 74 of the flexible hose 70 (FIG. 5).

A decorative panel 80 may further be provided and engaged or attached onto the casing 50, and includes one or more holes 81, 82 formed therein, and aligned with the apertures 53 and the passage 54 of the casing 50 respectively, and includes a decorative pattern or outer contour 83, such as flower, formed or provided thereon, for decorative purposes.

A guide cap 60 is engageable or attachable onto the decorative panel 80, and includes one or more latches or hooks or catches 61 extended therefrom, and engageable through the holes 81 of the decorative panel 80 and the apertures 53 of the casing 50 respectively, and engageable with the peripheral flange 52 of the casing 50, for attaching or securing the cap 60 and the decorative panel 80 to the casing 50.

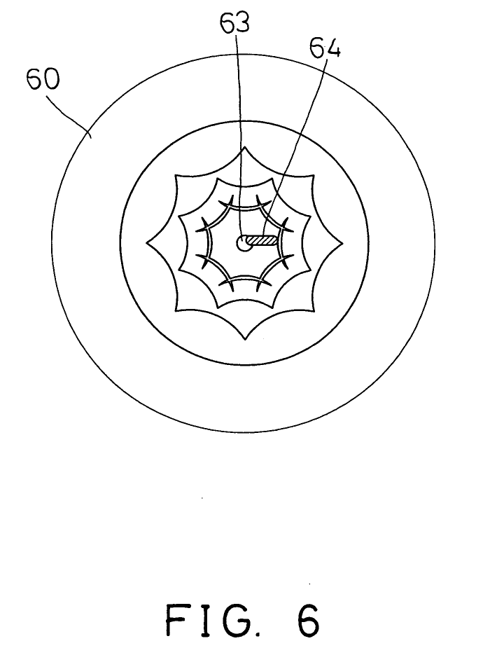

The cap 60 includes a port 62 extended therefrom, and a bore 63 formed through the port 62 (FIGS. 2 and 4-7). The port 62 is engageable into and fixable to the other end 74 of the flexible hose 70, for allowing the water from the nozzle 14 to flow out through the bore 63 of the port 62 or of the cap 60 via the flexible hose 70.

In operation, the water flowing out through the bore 63 of the port 62 or of the cap 60 may apply a fluid force against the flexible hose 70 and the cap 60, to elevate the casing 50 and the decorative panel 80 and the cap 60, and thus to randomly swing the flexible hose 70 and the cap 60 and the casing 50 and the flexible pipe 40 and the cap 60, in order to randomly sprinkle or spray the water, best shown in FIG. 8.

It is to be noted that the decorative panel 80 may be formed into various decorative patterns or outer contours 83, such as flower, animals, airplanes, or the like, for decorative purposes. The decorative panel 80 may be optionally, but not necessarily attached to the casing 50.

As shown in FIGS. 2 and 4-7, the cap 60 may further include a protrusion 64 extended therefrom, such as partially extended into the bore 63, to partially shield the water flowing passage through the bore 63 of the port 62 or of the cap 60, and to allow the water to further apply a water flowing force or moving force against the cap 60, to further cause the casing 50 and the decorative panel 80 and the cap 60 to move or jump or fly here and there.

Accordingly, the water sprinkler in accordance with the present invention includes a randomly swinging structure or device for randomly sprinkling or spraying the water, and for allowing the water to randomly swing or spray around the water sprinklers.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A water sprinkler comprising:
a base,
a nozzle attached to said base, and including an inlet for coupling to water reservoir, and including an outlet,
a tubular member attached to said base,
a flexible hose extended through and supported by said tubular member, and including a first end attached to said outlet of said nozzle, and including a second end, and
a casing attached to said second end of said flexible hose, and arranged to allow water from said nozzle to flow through said flexible hose and to flow out of said casing, and to force said casing to randomly swing relative to said base, and to randomly spraying the water.

2. The water sprinkler as claimed in claim 1, wherein said base includes a chamber formed therein, and an orifice formed in outer peripheral portion and communicating with said chamber thereof, to receive said nozzle.

3. The water sprinkler as claimed in claim 2, wherein said base includes an opening formed therein and communicating with said chamber thereof, for allowing said nozzle to be engaged into said chamber thereof.

4. The water sprinkler as claimed in claim 3, wherein said base includes a cap attached thereto, to enclose said opening thereof, and to retain said nozzle within said chamber of said base.

5. The water sprinkler as claimed in claim 1, wherein said base includes at least one projection extended downwardly therefrom, for engaging into ground.

6. The water sprinkler as claimed in claim 1 further comprising a flexible pipe engaged onto said flexible hose, to resiliently support said flexible hose in position.

7. The water sprinkler as claimed in claim 5 further comprising a barrel attached onto said tubular member, said flexible hose being extended through said barrel.

8. The water sprinkler as claimed in claim 7, wherein said barrel includes a bore formed therein, to receive a first end of said flexible pipe.

9. The water sprinkler as claimed in claim 8, wherein said casing includes a bore formed therein, to receive a second end of said flexible pipe.

10. The water sprinkler as claimed in claim 1 further comprising a cap attached to said casing.

11. The water sprinkler as claimed in claim 10, wherein said casing includes a peripheral flange extended therefrom, and having at least one aperture formed therein, said cap includes at least one catch extended therefrom, and engageable through said at least one aperture of said casing, to attach said to said casing.

12. The water sprinkler as claimed in claim 11 further comprising a panel attached to said casing and secured between said casing and said cap.

13. The water sprinkler as claimed in claim 10, wherein said cap includes a port extended therefrom, and a bore formed through said port, said port is attached to said second end of said flexible hose, and, to receive water from said flexible hose.

14. The water sprinkler as claimed in claim 13, wherein said cap includes a protrusion partially extended into said bore of said cap, to partially shield a water flowing passage through said bore of said port.
